(19) United States
(12) Patent Application Publication
(10) Pub. No.: US 2024/0144398 A1
(43) Pub. Date: May 2, 2024

(54) CHARGING SERVICE PROVIDING SERVER, AND METHOD FOR VEHICLE CHARGING

(71) Applicant: TBU INC., Seoul (KR)

(72) Inventors: Sang Jin PAIK, Seoul (KR); Junggwon SHIN, Gyeonggi-do (KR)

(73) Assignee: TBU INC., Seoul (KR)

(21) Appl. No.: 18/279,877

(22) PCT Filed: Nov. 12, 2021
(86) PCT No.: PCT/KR2021/016532

§ 371 Date: Sep. 1, 2023

(30) Foreign Application Priority Data
Mar. 2, 2021 (KR) 10-2021-0027434

(51) Int. Cl. G06Q 50/06; B60L 53/57; B60L 53/64; B60L 53/68; G06Q 10/047; G06Q 10/0631; G06Q 30/0207

(52) U.S. Cl. CPC G06Q 50/06; B60L 53/57; B60L 53/64; B60L 53/68; G06Q 10/047; G06Q 10/06311; G06Q 30/0207

(57) ABSTRACT

Provided is a charging service providing server including a storage, a communication interface unit, a memory, and a processor that executes instructions stored in the memory. The processor of the charging service providing server, by executing instructions, receives charging service call information from an external device through the communication interface unit, analyzes the availability of a charging service, based on the received charging service call information and charging service status information stored in the storage, to transmit the analysis result to the external device through the communication interface unit, and transmit charging service operation information to a charging service technician's terminal according to the analysis result.

### TECHNICAL FIELD

The disclosure relates to a charging service providing server and a charging service providing method for vehicle charging.

### BACKGROUND ART

The electric vehicle market is rapidly increasing due to the rapidly growing demand for electric vehicles. Nevertheless, electric vehicle charging infrastructure is insufficient, and it is difficult to build charging infrastructure in areas with a large number of multi-family houses or old buildings.

There is a demand for a new type of solution to the time constraints required for charging electric vehicles and the space constraints required for installing chargers.

### DISCLOSURE

### Technical Problem

Provided are a charging service providing server and a charging service providing method for vehicle charging to determine a charging service providing plan for assigning the optimal charging service technician to clients.

### Technical Solution

According to an aspect of the disclosure, a charging service providing server for vehicle charging includes storage, a communication interface unit, memory configured to store instructions, and a processor configured to receive charging service call information from at least one external device through the communication interface unit by executing the instructions, set one or more paths for each charging service technician to travel to at least one client who called charging service using the received charging service call information, charging service status information stored in the storage, and road condition information, calculate a reward value by applying a path selection model to the one or more paths, the path selection model reflecting the cost of the charging service technician's movement and the gain of providing the charging service, determine a charging service providing plan for assigning an optimal charging service technician to the at least one client based on the calculated reward value, and transmit an expected result according to the charging service providing plan to the at least one external device through the communication interface unit.

According to another aspect of the disclosure, a charging service providing method for vehicle charging, the method includes receiving charging service call information from at least one external device, setting one or more paths for each charging service technician to travel to at least one client who called charging service using the received charging service call information, charging service status information stored in a charging service providing server, and road condition information, calculating a reward value by applying a path selection model to the one or more paths, the path selection model reflecting the cost of the charging service technician's movement and the gain of providing the charging service, and determining a charging service providing plan for assigning an optimal charging service technician to the at least one client based on the calculated reward value, and transmitting an expected result according to the charging service providing plan to the at least one external device.

According to another aspect of the disclosure, a computer-readable recording medium on which programs to be executed on a computer are recorded includes instructions for setting one or more paths for each charging service technician to travel to at least one client who called charging service using the received charging service call information, charging service status information stored in a charging service providing server, and road condition information, calculating a reward value by applying a path selection model to the one or more paths, the path selection model reflecting the cost of the charging service technician's movement and the gain of providing the charging service, and determining a charging service providing plan for assigning an optimal charging service technician to the at least one client based on the calculated reward value, and instructions for transmitting an expected result according to the charging service providing plan to the at least one external device.

### DESCRIPTION OF DRAWINGS

FIG. 1 is a diagram for illustrating a charging service environment for vehicle charging;

FIG. 2 is a diagram for illustrating the configuration and operation of a vehicle;

FIG. 3 is a diagram for illustrating the configuration and operation of a user terminal;

FIG. 4 is a diagram for illustrating the configuration and operation of a charging service providing server for vehicle charging;

FIG. 5 is a diagram for illustrating a process of determining a charging service providing plan and providing a charging service for vehicle charging;

FIG. 6 is a diagram for illustrating a user interface when a charging service support application is executed for vehicle charging;

FIGS. 7a, 7b, 7c, and 7d are diagrams for illustrating factors that are considered according to a charging service technician's movement in a process of determining a charging service providing plan according to client requests occurring in real time;

FIG. 8 is a diagram for illustrating a path selection model that reflects the costs of a charging service technician's movement and the gains of providing a charging service;

FIGS. 9 and 10 are diagrams for illustrating an example of determining a charging service providing plan;

FIGS. 11 and 12 are diagrams for illustrating a user interface indicating an expected result according to a charging service providing plan; and

FIG. 13 is a diagram for illustrating a user interface which provides a chatting window for conversations with a charging service technician; and

FIG. 14 is a flowchart illustrating a charging service providing method for vehicle charging.

### MODE FOR INVENTION

Hereinafter, various embodiments are described in detail with reference to the drawings. To more clearly describe the characteristics of the embodiments, a detailed description of matters widely known to those skilled in the art to which the following embodiments belong are omitted.

When a component is said to be “connected” to another component in this specification, this includes not only the case of being “directly connected”, but also the case of being “connected via the other component in between”. In addition, when a component “includes” another component, this indicates the component does not exclude other components, but may further include other components unless otherwise specified.

Further, terms including ordinal numbers such as “first” or “second” used in this specification may be used to describe various components, but the components should not be limited by the terms. These terms are only used for the purpose of distinguishing one component from another.

The present embodiments relate to a charging service providing server and a charging service providing method for vehicle charging, and detailed descriptions of matters widely known to those skilled in the art to which the following embodiments belong are omitted.

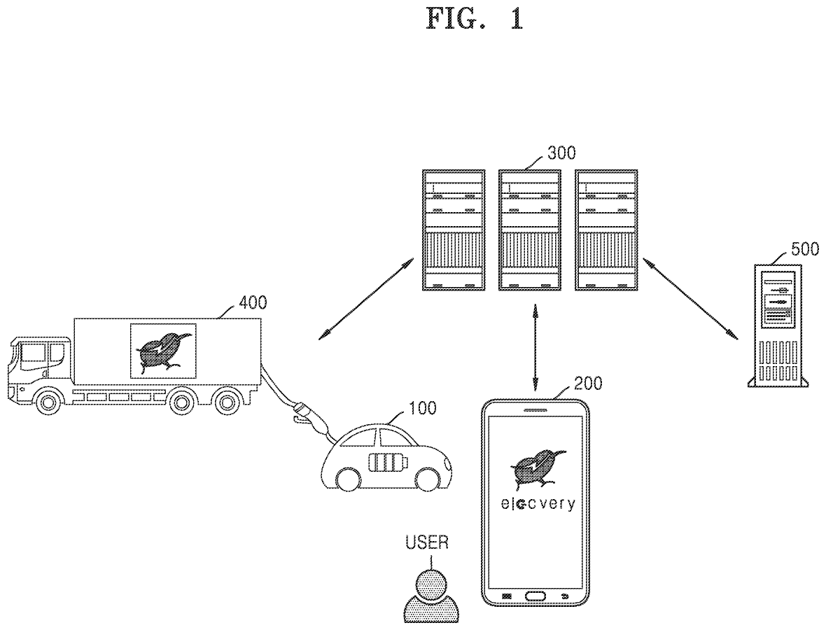

FIG. 1 is a diagram for illustrating a charging service environment for vehicle charging.

A vehicle 100 refers to a means of transport or movement having a rechargeable battery device. For example, the vehicle 100 may include an electric vehicle, a hybrid car, an electric scooter, an electric kickboard, or an electric two-wheeled vehicle that can be charged with electricity. The vehicle 100 may operate by properly distributing power of the battery device to parts inside the vehicle 100 where power supply is required. When the power is supplied to various parts of the vehicle 100 from the battery device, the battery device is discharged and needs to be charged.

A user terminal 200 which is a terminal device of a client (user) who owns or uses the vehicle 100 may request the use of charging service from a charging service providing server 300. The user terminal 200 may transmit charging service call information to the charging service providing server 300, and may receive an analysis result including whether or not the charging service can be provided from the charging service providing server 300. The client (user) may call an charging service technician to a desired place where the vehicle 100 is located at a desired time through a real-time call or a reserved call using the user terminal 200. In addition, the client may preset information corresponding to the condition for executing the charging service and the charging service call information so that the charging service providing server 300 is capable of providing the charging service when a certain condition is satisfied, although there is no request for the use of the charging service from the user terminal 200.

The charging service providing server 300 may provide charging service at a time and a place desired by a client. The charging service providing server 300 may use the information received from the vehicle 100 or the user terminal 200 to analyze whether the charging service is available and to provide the charging service depending on the analysis result. The charging service providing server 300 may be implemented with technology such as cloud computing. The charging service providing server 300 may store company information of a plurality of charging service providers, and may provide a charging service providing virtual machine for managing charging service for each company.

An charging service technician terminal 400 may receive charging service operation information from the charging service providing server 300. The charging service operation information may include information on a vehicle to be provided with the charging service, information on a charging type, information on a charging service providing time, and information on a charging place. The charging service technician terminal 400 may be a terminal device carried by the charging service technician or a terminal device built into a means of transport carrying the charging device. The means of transport performing the charging service may include a mobile charging device or a built-in charging device. The means of transport performing the charging service may stand by in a charging station providing charging service or may be placed in a certain area for a certain period of time in the form of a pop-up means of transport.

A traffic information providing server 500 may be a server providing road condition information. The charging service providing server 300 may be connected to the traffic information providing server 500 and collect detailed road information or traffic information necessary to determine a charging service providing plan.

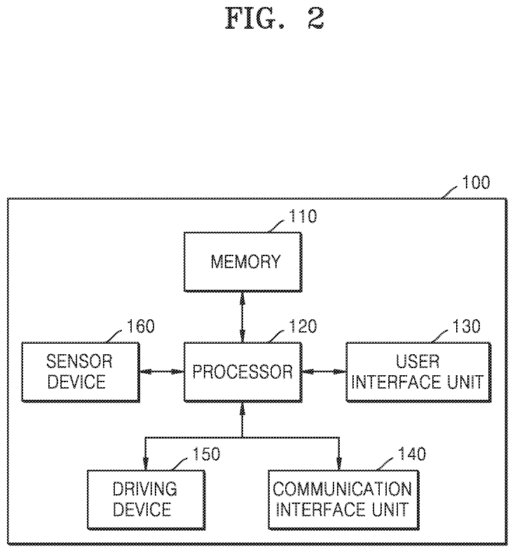

FIG. 2 is a diagram for illustrating the configuration and operation of the vehicle 100.

Referring to FIG. 2, the vehicle 100 includes memory 110, a processor 120, a user interface unit 130, a communication interface unit 140, a driving device 150, and a sensor device 160. Those skilled in the art related to the present embodiment may understand that other general-purpose components may be further included in addition to the components shown in FIG. 2.

The memory 110 may store software and/or computer programs. The memory 110 may store instructions executable by the processor 120. The processor 120 may access and use data stored in the memory 110 or store new data in the memory 110. The processor 120 may execute the instructions stored in the memory 110. The processor 120 may include at least one processing module.

The user interface unit 130 may include an input unit for receiving an input from a client (user) such as a driver and an output unit for providing information. The input unit may receive various types of inputs from the client (user), and the output unit may include a display panel and a controller controlling the display panel. The user interface unit 130 may be provided in the form of a touch screen in which a display panel and a touch panel are combined.

The communication interface unit 140 may perform wired/wireless communication with other devices or networks. The communication interface unit 140 may include a communication module supporting at least one of various wired/wireless communication methods. The communication interface unit 140 may be connected to a device located outside the vehicle 100 to transmit and receive signals or messages including data.

The driving device 150 may include a brake, an accelerator, a steering device, a battery device, a driving motor, a transmission, and the like.

The sensor device 160 may include sensors configured to sense information about the environment in which the vehicle 100 is located and one or more actuators configured to modify the position or orientation of the sensors. According to an embodiment, the sensor device 160 may include at least one of a global positioning system (GPS), a camera, an inertial sensor, an acceleration sensor, a geomagnetic sensor, a temperature sensor, a humidity sensor, a barometric pressure sensor, a distance sensor, a speed sensor, an inertial measurement unit (IMU), a RADAR device, and a LIDAR device, but is not limited thereto.

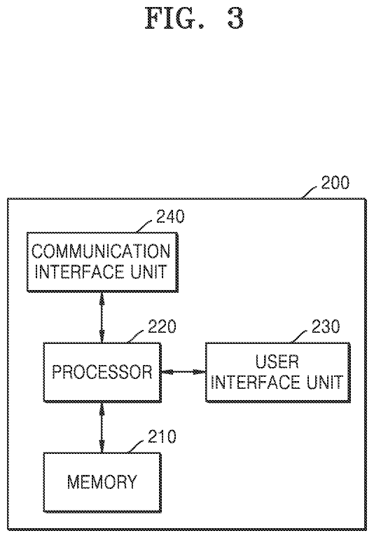

FIG. 3 is a diagram for illustrating the configuration and operation of the user terminal 200.

Referring to FIG. 3, the user terminal 200 includes memory 210, a processor 220, a user interface unit 230, and a communication interface unit 240. Those skilled in the art related to the present embodiment may understand that other general-purpose components may be further included in addition to the components shown in FIG. 3.

The memory 210 may store software and/or computer programs. For example, the memory 210 may store programs such as applications, application programming interfaces (APIs), and various types of data. The memory 210 may store instructions executable by the processor 220.

The processor 220 may access and use data stored in the memory 210 or store new data in the memory 210. The processor 220 may execute the instructions stored in the memory 210. The processor 220 may execute an application installed on the user terminal 200.

The processor 220 may include at least one processing module. The processor 220 may control other components included in the user terminal 200 to perform an operation corresponding to an execution result of instructions or computer programs.

The user interface unit 230 may include an input unit for receiving an input from a client (user) and an output unit for providing information. The input unit may receive various types of inputs from the client (user), and may include at least one of a keypad, a touch panel, and a pen recognition panel. The output unit may include a display panel and a controller that controls the display panel, and may be implemented in various ways, such as liquid crystal display (LCD), organic light emitting diodes (OLED) display, active-matrix organic light-emitting diode (AM-OLED), and plasma display panel (PDP). The display panel may be implemented to be flexible or wearable. The user interface unit 230 may be provided in the form of a touch screen in which a display panel and a touch panel are combined.

The communication interface unit 240 may perform wired/wireless communication with other devices or networks. The communication interface unit 240 may include a communication module supporting at least one of various wired/wireless communication methods. For example, the communication module may perform various types of mobile communication or ultra-wideband communication, e.g., short-distance communication such as Wi-Fi and Bluetooth, 3G, 4G, and 5G. The communication interface unit 240 may be connected to a device located outside the user terminal 200 to transmit and receive signals or messages including data.

The processor 220 may perform the following operations by executing the instructions stored in the memory 210.

The processor 220 may receive charging service call information through a user interface when a charging service support application is executed, and may transmit the charging service call information to the charging service providing server 300. For example, the processor 220 may automatically receive vehicle information including charge status information through the user interface by means of communication with the vehicle 100, and may manually receive user selection information including required charge level, requested charging time (valid work time), and charging location information through the user interface. The charge status information may include information about the full charge capacity of the battery device and information about the remaining charge capacity.

The processor 220 may receive, through the communication interface unit 240, an expected result according to a charging service providing plan from the charging service providing server 300 in response to transmitting the charging service call information.

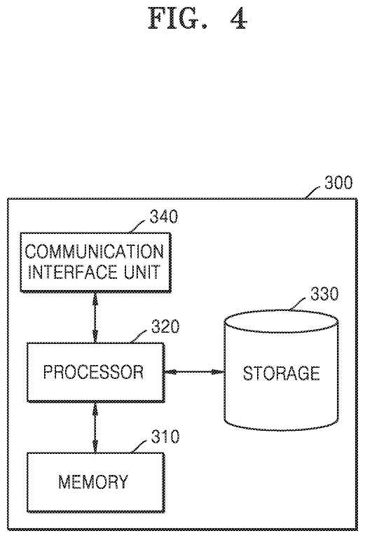

FIG. 4 is a diagram for illustrating the configuration and operation of the charging service providing server 300 for vehicle charging.

Referring to FIG. 4, the charging service providing server 300 includes memory 310, a processor 320, storage 330, and a communication interface unit 340. Those skilled in the art related to the present embodiment may understand that other general-purpose components may be further included in addition to the components shown in FIG. 4.

Each component of the block diagram of FIG. 4 may be separated, added, or omitted according to the implementation method of the charging service providing server 300. That is, depending on the implementation method, one component may be subdivided into two or more components, two or more components may be combined into one component, or some components may be added or removed.

The memory 310 may store instructions executable by the processor 320. The memory 310 may store software or programs.

The processor 320 may execute the instructions stored in the memory 310. The processor 320 may perform overall control of the charging service providing server 300. The processor 320 may obtain information and requests received through the communication interface unit 340, and may store the received information in the storage 330. In addition, the processor 320 may process the received information. For example, the processor 320 may obtain information used to provide charging service from information received from the user terminal 200 or perform a processing operation for managing the received information to store the information in the storage 330. In addition, the processor 320 may transmit information for providing the charging service to the user terminal 200, the charging service technician terminal 400, and the traffic information providing server 500 through the communication interface unit 340 using data or information stored in the storage 330 in response to the request obtained from the user terminal 200.

The storage 330 may store various software and information necessary for the charging service providing server 300 to provide the charging service. For example, the storage 330 may store programs and applications executed in the charging service providing server 300, and various data or information used for the charging service. The storage 330 may store information received from the vehicle 100, the user terminal 200, the charging service technician terminal 400, the traffic information providing server 500, and the like. In addition, the storage 330 may store and manage information for managing the charging service for each vehicle 100 or each client (user) in a database.

For example, the storage 330 may store and manage the charging service status information. The charging service status information may include charging service technician status information, and charging device status information, and may also include charging station status information for each charging station. The charging service technician status information may include status information or location information of the charging service technician. The charging device status information may include chargeable battery amount information or charging type information of the charging device. The charging station status information may include status information or charging type information of the charging station.

For another example, the storage 330 may store vehicle information, vehicle usage pattern information, and charging pattern information of a client (user) in correspondence with vehicle identification information or client (user) identification information. The information stored in the storage 330 may be converted into big data, and may be used to predict information used for vehicle management through various types of algorithms, mathematical models, and statistical models. For example, the processor 320 may estimate the deterioration of the battery device based on a charging service log file stored in the storage 330, and may analyze the charging pattern. The processor 320 may predict the life of the battery device by applying the deterioration and charging pattern of the battery device to a battery life prediction model.

The communication interface unit 340 may communicate with the external device such as the vehicle 100, the user terminal 200, the charging service technician terminal 400, and the traffic information providing server 500. For example, the charging service providing server 300 may receive a charging service request or preset information for facilitating a charging service environment from the user terminal 200, and may provide information related to the charging service in response to a request from the external device.

The charging service providing server 300 may include a load balancing server and functional servers providing charging service. For example, the functional servers may include a server for receiving a charging service request, a server for managing charging service status information, a server for determining a charging service providing plan, and the like. The charging service providing server 300 may include a plurality of servers divided by function or an integrated server.

The processor 320 may perform the following operations by executing the instructions stored in the memory 310.

According to an embodiment, the processor 320 may receive the charging service call information from at least one external device through the communication interface unit 340. For example, the processor 320 may transmit a charging service providing inquiry to the external device in response to receiving the automatic call information based on the charge status information of the vehicle 100 from the external device (e.g., user terminal 200) through the communication interface unit 340. For a client who subscribes to charging service, when the battery of the vehicle 100 is lowered to a certain level or less, an automatic call to the charging service providing server 300 may be made although the client does not directly call the charging service. The charging service providing inquiry may include an expected result or guidance message when the charging service is provided based on charge status information or charging place information included in the automatic call information. The processor 320 may receive the charging service call information from the external device in response to transmitting the charging service providing inquiry. For another example, when receiving the automatic call information based on the charge status information of the vehicle 100, the processor 320 of the charging service providing server 300 may obtain the charging service call information based on information of the user subscribing to the charging service stored in the charging service providing server 300. For another example, based on the charge status information of the vehicle 100, the external device may inquire the client (user) whether or not to make an automatic call through a push message, may obtain approval from the client (user), and may transmit the charging service call information to the charging service providing server 300.

According to an embodiment, the processor 320 may set one or more paths for each charging service technician to travel to at least one client who called the charging service using the received charging service call information, charging service status information stored in the storage 330, and road condition information, may calculate a reward value by applying a path selection model to the one or more paths, the path selection model reflecting the cost of the charging service technician's movement and the gain of providing the charging service, and may determine a charging service providing plan for assigning an optimal charging service technician to the at least one client based on the calculated reward value. The charging service providing plan may provide the optimal charging service to the client based on real-time information, according to the client's request occurring in real time. This is to provide high-quality charging service by optimally arranging limited resources, e.g., an charging service technician or an charging service technician's charging device, used for providing charging service. The processor 320 may transmit an expected result according to the charging service providing plan to at least one external device through the communication interface unit 340.

According to an embodiment, the processor 320 may determine one or more paths for each charging service technician to travel to at least one client, and may calculate a reward value by applying the path selection model to the one or more paths. The processor 320 may assign the optimal charging service technician to at least one client based on the calculated reward value.

According to an embodiment, the path selection model may determine the cost of the charging service technician's movement based on the road condition information for each road constituting the path, and may determine the gain of charging the charging device at the charging station and the gain of completing the providing of charging service in the process of providing the charging service based on the charging service status information. The cost of the charging service technician's movement may be determined according to detailed road information and traffic information for each road. The gain of completing the providing of charging service may be determined in proportion to the degree to which the requested charging service time by the client overlaps the charging service providing time. The gain of charging the charging device at the charging station may be determined in inverse proportion to the remaining battery level of the charging device.

According to an embodiment, the processor 320 may estimate the charging service providing time according to the charging service providing plan, and may transmit an expected result including the estimated charging service providing time to at least one external device through the communication interface unit 340.

According to an embodiment, in response to receiving approval information of the charging service providing plan from at least one external device, the processor 320 may transmit the charging service operation information to the charging service technician terminal 400 of the optimal charging service technician corresponding to the charging service providing plan through the communication interface unit 340.

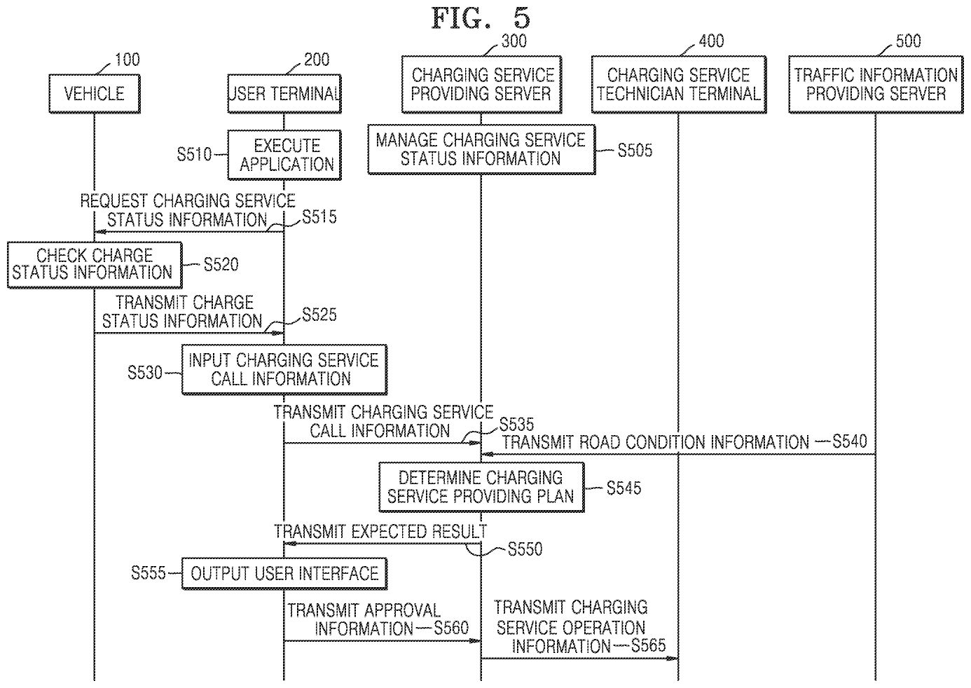

FIG. 5 is a diagram for illustrating a process of determining a charging service providing plan and providing charging service for vehicle charging.

The charging service providing server 300 may manage charging service status information (S505). The charging service providing server 300 may check whether the charging service technician is providing service or is on standby through the charging service technician status information, and check where the charging service technician is located. The charging service providing server 300 may check the remaining battery level enough for the charging device to provide the charging service through the charging device status information. The charging service providing server 300 may check the location and availability information of each charging station through the charging station status information. The charging service providing server 300 may reflect in real time and manage the charging service status information in a database.

The user terminal 200 may execute a charging service support application (S510). The charging service support application may be installed in the user terminal 200 or the vehicle 100, but it is assumed that the charging service support application is installed in the user terminal 200, as shown in FIG. 5, for the convenience of explanation.

The user terminal 200 may request the charge status information from the vehicle 100 (S515). When communication connection between the vehicle 100 and the user terminal 200 is enabled, the user terminal 200 may automatically request vehicle information from the vehicle 100 upon the execution of the charging service support application to obtain the latest vehicle information. However, unlike shown in FIG. 5, the client (user) may manually input vehicle information into the user terminal 200.

The vehicle 100 may check the charge status information (S520).

The vehicle 100 may transmit the charge status information to the user terminal 200 (S525). The user terminal 200 may update vehicle information by receiving current charge status information of the vehicle 100 from the vehicle 100.

The user terminal 200 may receive charging service call information (S530). The user terminal 200 may receive the vehicle information including charge status information of the vehicle 100, the required charge level, the requested charging time (valid work time), and the charging location information.

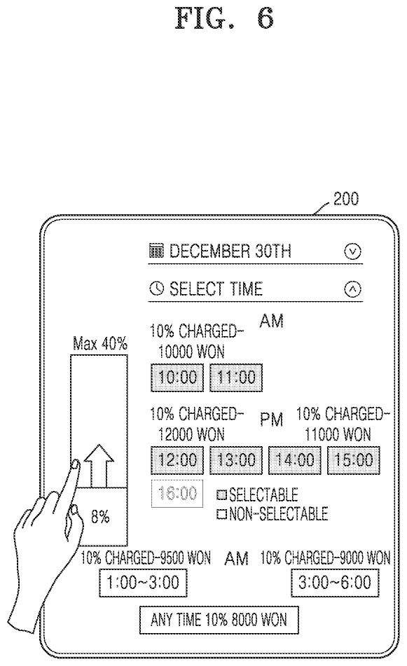

FIG. 6 is a diagram for illustrating a user interface when a charging service support application is executed for vehicle charging.

The user terminal 200 may provide a user interface capable of receiving charging service call information. As shown in FIG. 6, when the charging service support application is executed, the client (user) may check available time slots, costs, and a control bar for selecting the required charge level at a glance on the user interface. The cost may be different for each of the time slots available for reservation by the client (user), and it is possible to request charging at a slightly discounted price during the early morning reservation hours. The client (user) may determine the required charge level by pulling up the control bar while touching the screen.

Referring back to FIG. 5, the user terminal 200 may transmit charging service call information to the charging service providing server 300 (S535). The charging service call information may include vehicle information and user selection information. The charging service providing server 300 may receive the charging service call information from the user terminal 200.

Unlike the charging service providing server 300 shown in FIG. 5, it is possible to preset information corresponding to the condition for executing the charging service and the charging service call information to provide the charging service when a certain condition is satisfied, without receiving the charging service call information. Accordingly, when detecting the condition for executing the charging service (e.g., when the charge status information of the vehicle 100 is less than a preset criterion) the charging service providing server 300 may obtain information corresponding to the preset charging service call information. For convenience of explanation, an example of the charging service providing server 300 receiving charging service call information from an external device is described below, but is not limited thereto.

The traffic information providing server 500 may transmit road condition information to the charging service providing server 300 (S540). The charging service providing server 300 may receive the road condition information from the traffic information providing server 500. The road condition information may be updated in real time or periodically, or may be provided upon request from the charging service providing server 300.

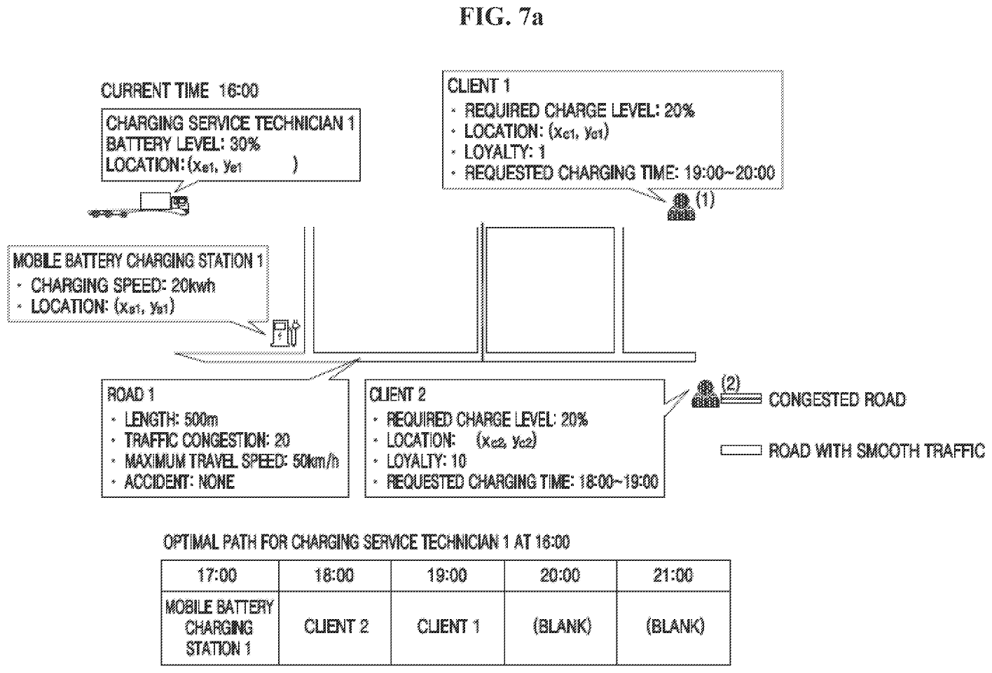

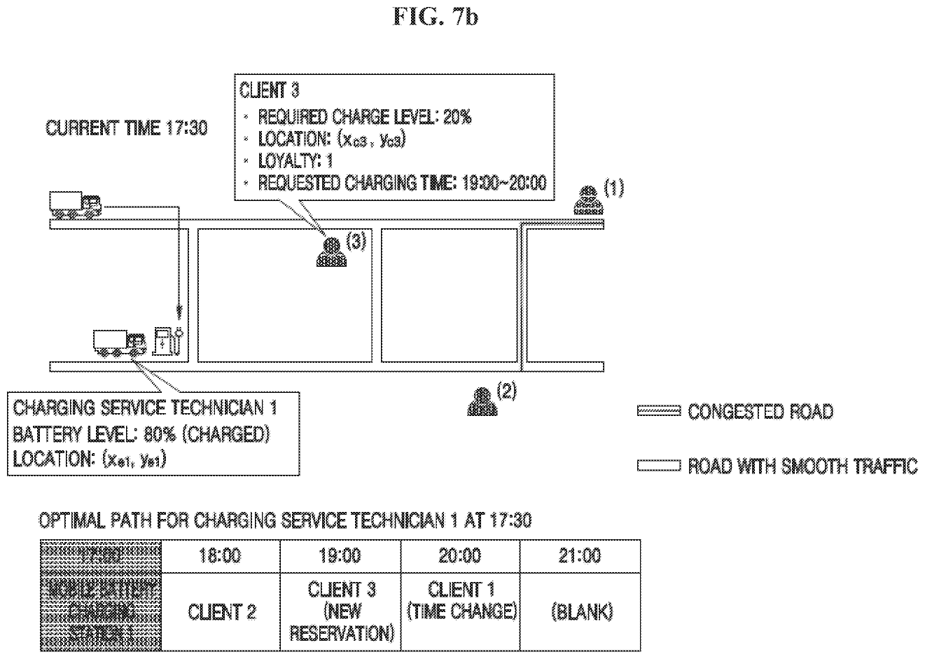

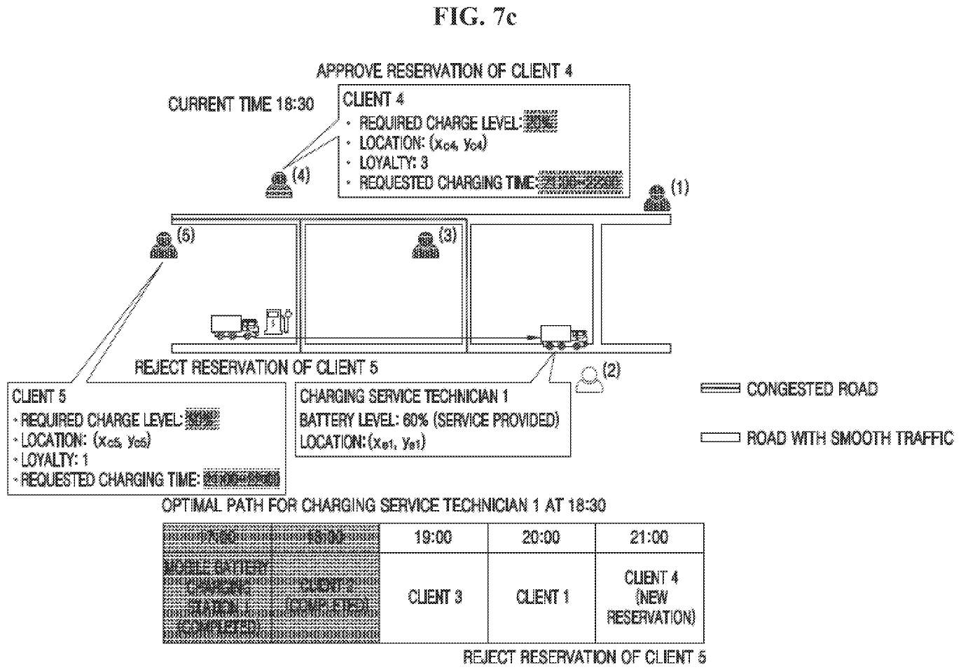

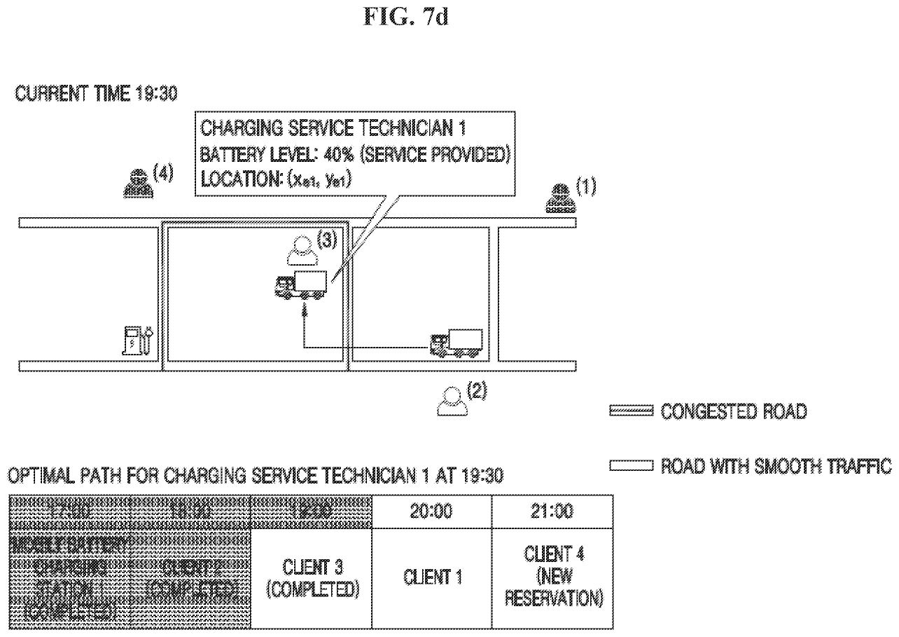

The charging service providing server 300 may determine a charging service providing plan for assigning an charging service technician to at least one client who has called the charging service by using the charging service call information, the charging service status information, and the road condition information (S545). The charging service providing server 300 may assign the charging service technician capable of satisfying the client's request included in at least one piece of the charging service call information to the client in consideration of the available charging service technician and charging device. This is described in detail with reference to FIGS. 7a, 7b, 7c, 7d, 8, 9, and 10 below.

FIGS. 7a, 7b, 7c, and 7d are diagrams for illustrating factors that are considered according to the movement of an charging service technician in a process of determining a charging service providing plan according to a client request occurring in real time.

FIG. 7a shows an example of a path along which charging service technician 1 with a charging device travels to provide charging service to client 1 and client 2 on the basis of a specific time.

The travel path includes a plurality of roads, where a connection point between adjacent roads corresponds to a node, and each road may correspond to an edge connecting the nodes at both ends. Thus, the road condition information may be represented as an edge feature. For example, road 1 may be expressed as (500, 200), which indicates that the length of the road is 500 meters and the traffic congestion is 20, and the road condition information may further include other information.

FIG. 7a shows the location of charging service technician 1 with a charging device when charging service calls are received from client 1 and client 2 at 16:00. Referring to FIG. 7a, available charging service technician 1 who is not currently performing a charging service operation has a charging device with a remaining battery level of 30%. Information on each client may include a required charge level, client loyalty related to the charging service, location information, requested charging time (valid work time), and the like. For example, it is shown that client 2 is a client (user) who is at a location corresponding to a certain latitude and longitude, with a required charge level for the battery of the vehicle 100 of 20%, a loyalty index of 10, and requests that the charging service be completed between 18:00 and 19:00. It is shown that client 2 is a highly loyal client who uses the charging service more frequently than client 1, and the requested charging time of client 2 is earlier than that of client 1.

In the situation shown in FIG. 7a, the charging service providing server 300 may check a path for charging service technician 1 with the charging device to reach both client 1 and client 2 who called the charging service. To provide charging service to both client 1 and client 2, the charging service providing server 300 may determine the movement of charging service technician 1 in consideration of the remaining battery level of the charging device of charging service technician 1 and the requested charging time of the two clients. The charging service providing server 300 may set the current location of charging service technician 1 as a starting point, may set client 1, client 2, or mobile battery charging station 1 as a destination of charging service technician 1, and may set at least one of the two clients as an essential transit point. For the different paths that charging service technician 1 can travel, the charging service providing server 300 may determine a travel path in consideration of the loyalty and required charge level of each client (user), the length and traffic congestion of each path, the remaining battery level of the charging device before and after providing the charging service, the location of the charging station, and the like. The charging service providing server 300 may reject the client's charging service request when it is determined that the charging service technician is not capable of providing the charging service to the client in time. The charging service providing server 300 may determine a path so that charging service technician 1 is able to complete the providing of charging service to client 2 by 18:00 and complete the providing of charging service to client 1 by 19:00 after moving to a mobile battery charging station 1 and charging the charging device by 17:00, considering that the charging time requested by the two clients is 2 hours later than 16:00 and the remaining battery level (30%) of charging service technician 1's charging device is insufficient to provide charging service to both client 1 and client 2.

FIG. 7b is a diagram illustrating a situation in which charging service technician 1 completes charging of the charging device at the mobile battery charging station 1 at 17:30 and a situation in which client 3 requests a new reservation. It is shown that the remaining battery level has increased from 30% to 80% by charging the battery of the charging device owned by charging service technician 1, thereby meeting the required charge level. Client 3 has requested a new reservation for charging service, and the requested charging time is between 19:00 and 20:00, overlapping with client 1. The charging service providing server 300 may determine that charging service technician 1 is able to travel from the location of client 2 to the location of client 3 in a shorter time than to the location of client 1, considering the distance and traffic congestion, and the remaining battery level of the charging device is sufficient to provide charging service to client 1 and client 3. The charging service providing server 300 may determine a path by determining that the charging service can be provided within the requested time by client 1 although the charging service is provided to client 3 before client 1, changing the estimated time for charging service technician 1 to complete the providing of charging service to client 1 from 19:00 to 20:00, and determining the estimated time to complete the providing of charging service to client 3 as 19:00.

FIG. 7c is a diagram illustrating a situation in which charging service technician 1 completes charging service for client 2 at 18:30, and a situation in which reservations are requested by client 4 and client 5. It is shown that when charging service technician 1 completes the providing of charging service by 20% to client 2, the remaining battery level of the charging device of charging service technician 1 changes from 80% to 60%. At this time, reservations are requested by client 4 and client 5, and the charging time requested by both clients is the same, from 21:00 to 22:00. After charging service technician 1 completes the providing of charging service to client 1 at 20:00, the charging service providing server 300 may predict that traveling to client 4 will take a shorter time than traveling to client 5 considering the distance and traffic congestion on roads, may determine that client 4 has higher loyalty than client 5, and may predict that the remaining battery level of the charging device of charging service technician 1 will be exhausted when considering the required charge level of client 5. Accordingly, the charging service providing server 300 may determine a path by determining that it is not possible to provide charging service to both client 4 and client 5 from 21:00 to 22:00, rejecting a reservation for charging service requested by client 5, and determining the expected time to complete the providing of charging service to client 4 as 21:00.

FIG. 7d is a diagram illustrating a situation in which charging service technician 1 completes the providing of charging service to client 3 and travels to client 1 at 19:30. It is shown that when charging service technician 1 completes the providing of charging service by 20% to client 3, the remaining battery level of the charging device of charging service technician 1 changes from 60% to 40%. Thereafter, charging service technician 1 may sequentially provide charging service to client 1 and client 4.

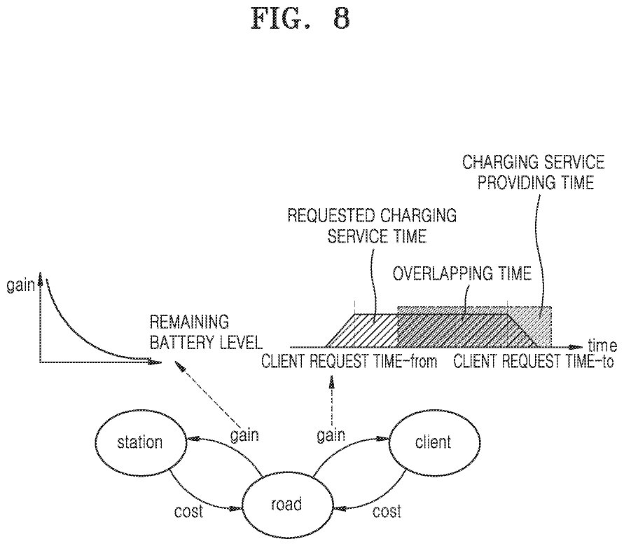

FIG. 8 is a diagram for illustrating a path selection model that reflects the cost of the charging service technician's movement and the gain of providing the charging service.

The path selection model may determine the cost of the charging service technician's movement based on the road condition information of each road constituting the path, and may determine the gain of charging the charging device at the charging station and the gain of completing the providing of charging service in a process of providing the charging service, based on the charging service status information. For each charging service technician's path, when the path selection model is applied, a reward value may be calculated by summing costs and gains. As a result, based on the calculated reward value, the optimal charging service technician and path for clients may be determined.

The cost of the charging service technician's movement may be determined according to detailed road information and traffic information of each road. For example, at least one of unique characteristic information, such as the start point and end point, length, and speed limit of each road, and variable characteristic information, such as traffic congestion and road construction, may be considered. The longer the road the charging service technician has to travel to reach the client and the higher the traffic congestion, the higher the cost is. Therefore, when selecting a path, an algorithm for selecting a path with the shortest distance or shortest time may be used.

The gain of completing the providing of the charging service may be determined in proportion to the degree to which the requested charging service time by the client overlaps the charging service providing time. In other words, the gain of completing the providing of the charging service may be determined according to the extent to which the providing of charging service is completed within the requested charging time (valid work time) by the client. Referring to FIG. 8, the gain of completing the providing of charging service may be determined in proportion to the length of the time in which the requested charging service time overlaps the charging service providing time. For example, the gain may be determined depending on whether the time when the charging service technician arrives and provides the charging service is all or part of the requested charging time specified by the client.

The gain of charging the charging device at the charging station may be determined in inverse proportion to the remaining battery level of the charging device. As shown in FIG. 8, as the remaining battery level of the charging device decreases, the gain of charging the charging device increases, and as the remaining battery level of the charging device increases, the gain of charging the charging device decreases. Accordingly, when the remaining battery level of the charging device for providing the charging service is sufficient, the charging device may not be charged at the charging station, and may be charged at the charging station only when it is not sufficient, thereby providing the fast charging service.

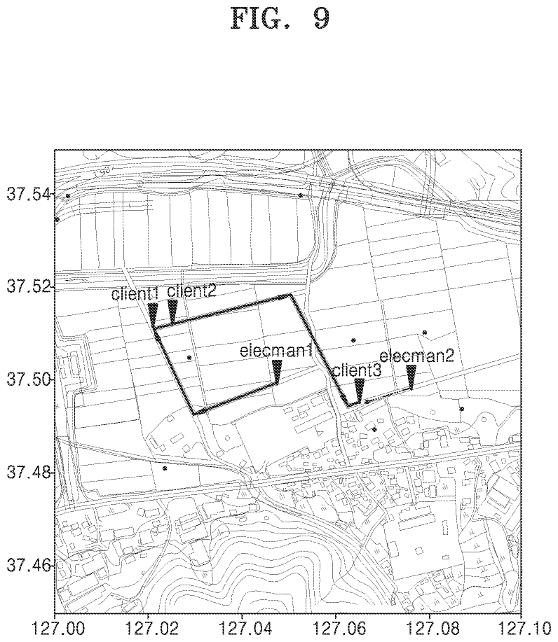

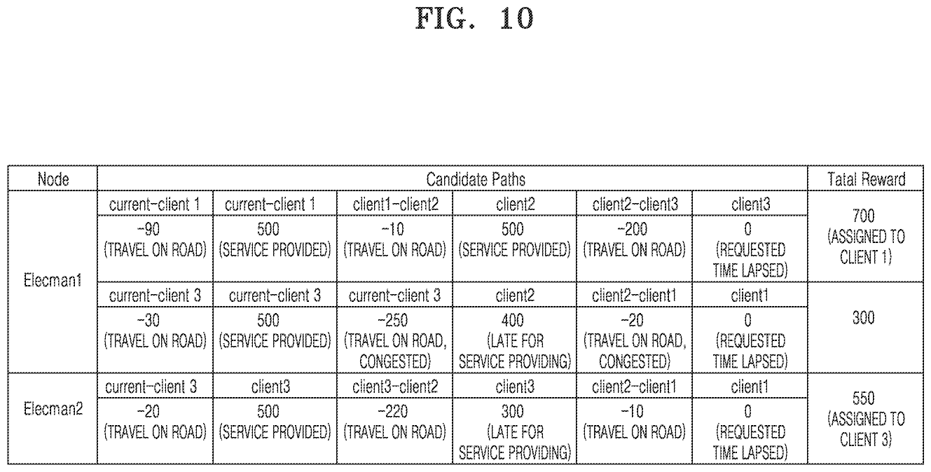

FIGS. 9 and 10 are diagrams for illustrating an example of determining a charging service providing plan.

In FIGS. 9 and 10, a case in which there are three clients and two charging service technicians is exemplified to illustrate a method by which the charging service providing server 300 determines the charging service providing plan. For the factors considered according to the movement of the charging service technician and the providing of the charging service described above in FIGS. 7A to 8, the charging service providing server 300 may determine the charging service providing plan by applying the path selection model which reflects the cost and the gain.

As shown in FIG. 9, upon the charging service calls from three clients (client 1, client 2, and client 3), the charging service providing server 300 may determine which of two charging service technicians (elecman 1 and elecman 2) to assign to each of the clients (client 1, client 2, client 3) and in which order. As shown in FIG. 10, the charging service providing server 300 may calculate a reward value for each charging service technician by applying the path selection model which reflects the cost of the charging service technician's movement and the gain of providing the charging service to various paths to each client to determine the charging service providing plan so that an optimal charging service technician is assigned in a given situation. Since the given situation information may change over time, the charging service providing server 300 may determine the charging service providing plan for each charging service technician when the charging service providing is completed or charging at the charging station is completed, that is, when the charging service technician is available.

Referring to FIG. 10, it is shown that two candidate paths are selected for charging service technician 1 (elecman 1), and one candidate path is selected for charging service technician 2 (elecman 2). That is, charging service technician 1 (elecman 1) may travel along candidate path 1 in the order of client 1, client 2, and client 3 from the current initial location, or candidate path 2 in the order of client 3, client 2, and client 1 from the initial location. Charging service technician 2 (Elecman 2) may travel along candidate path 3 in the order of client 3, client 2, and client 1 from the current initial location.

The charging service providing server 300 may determine the cost of the charging service technician's movement or the gain of providing the charging service for each step in the process of providing the charging service by applying the path selection model to candidate path 1, candidate path 2, and candidate path 3, and may determine a reward value. Referring to FIG. 10, since the total reward value for the candidate path 1 is 700, the total reward value for the candidate path 2 is 300, and the total reward value for the candidate path 3 is 550, charging service technician 1 (elecman 1) may be assigned to client 1 according to the candidate path 1, and charging service technician 2 (elecman 2) may be assigned to client 3 according to the candidate path 3. When charging service technician 2 (elecman 2) travels along candidate path 3 for client 2, traveling from the location of client 3 to the location of client 2 results in the cost of −220 and the gain of 300 due to delay in providing the charging service to client 2. However, when charging service technician 1 (elecman 1) travels along candidate path 1 for client 2, traveling from the location of client 1 to the location of client 2 results in the cost of −10 and the gain of 500 due to completion of the charging service for client 2. Thus, charging service technician 1 (elecman 1) may be assigned to client 2. As a result, in an example of FIG. 9, the charging service providing plan that optimally assigns two charging service technicians (elecman 1, and elecman 2) to three clients (client 1, client 2, and client 3) may include a case in which charging service technician 1 (elecman 1) first provides charging service to client 1 and then provides charging service to client 2 according to candidate path 1, and charging service technician 2 (elecman 2) provides charging service to client 3 according to candidate path 3.

As a result of applying the path selection model to all the paths for all available charging service technicians, charging service may not be available to a specific client within the requested time because all service calls are congested at a specific time or concentrated in a specific area. In this case, separate stand-by service agents may be put in. However, even when it is not possible to put in the agents, the specific client may be informed that the charging service is not available.

Referring back to FIG. 5, the charging service providing server 300 may transmit an expected result according to the charging service providing plan to the user terminal 200 (S550). The user terminal 200 may receive the expected result according to the charging service providing plan from the charging service providing server 300.

The user terminal 200 may output a user interface based on the expected result received from the charging service providing server 300 (S555). For example, the user terminal 200 may output the estimated arrival time of the charging service technician or the estimated charging service time on the user interface of the standby screen. The client (user) may determine whether to call the charging service by checking the estimation information output on the user interface.

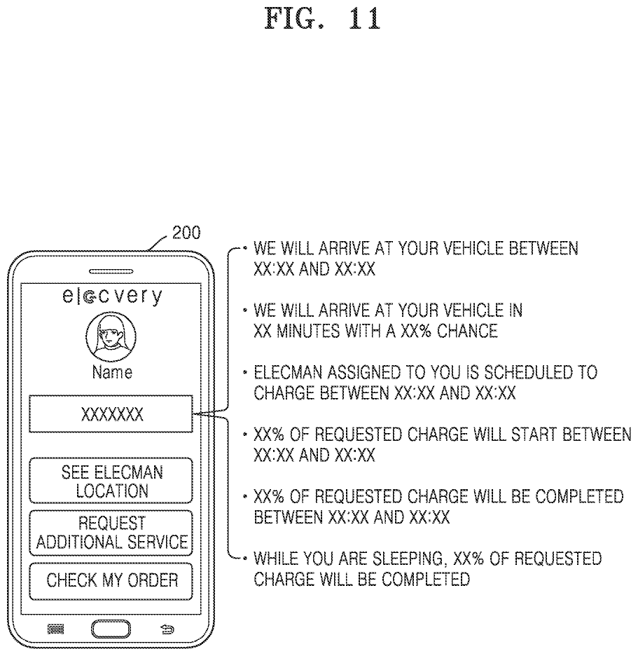

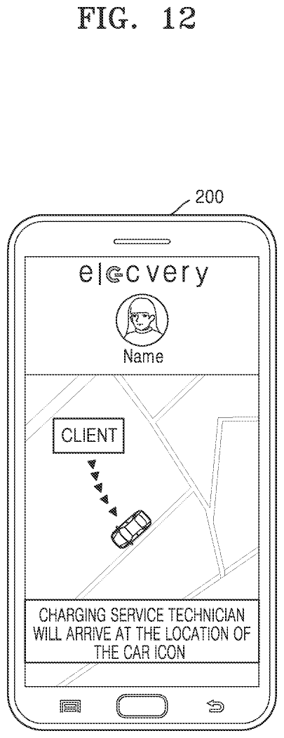

FIGS. 11 and 12 are diagrams for illustrating a user interface indicating an expected result according to the charging service providing plan.

Referring to FIG. 11, various types of messages of the expected result according to the charging service providing plan are shown. Referring to the various examples shown in FIG. 11, each message may include the estimated arrival time of the charging service technician or the estimated charging service time. In addition, probability information representing the accuracy of such estimation may be displayed together. In addition, when a charging service call is made at a certain location for providing charging service, such as a place where the number of charging service technicians per area is high or a place dedicated to charging, a phrase indicating that the estimated arrival time or the charging completion time is guaranteed may be included. In addition, a message for reminding the client (user) of the required charge level may be included. The client (user) may check the expected result according to the charging service providing plan displayed on the user interface, and may transmit approval information to the charging service providing server 300 through the user terminal 200.

Along with the message, detailed information of the charging service technician assigned to the client (user) may be provided. In addition, a menu button for inputting additional service or reference to be requested together with the charging service may be provided.

FIG. 12 shows the user interface that guides the client (user) to an alternative charging place to replace the charging location requested by the client (user) when the requested charging location is not suitable for providing charging service. For example, when the charging location requested by the client (user) is a place where access to outsiders is restricted, is not a service area, or is a place where the vehicle 100 cannot stop, such as in the middle of a highway, i.e., area where charging service is not available, the user interface may guide the client (user) to an alternative charging location closest to the location of the client (user). In addition, information on landmarks or nearby attractions around the alternative location may be provided to guide the client (user) to easily find the alternative charging location.

Referring back to FIG. 5, the user terminal 200 may transmit approval information of the charging service to the charging service providing server 300 (S560).

The charging service providing server 300 may transmit charging service operation information to the charging service technician terminal 400 of the charging service technician selected as the optimal charging service technician (S565). Accordingly, the charging service technician may grasp vehicle information of the vehicle 100 to be provided with the charging service, time information to provide the charging service, and charging location information, and the like, and the charging service technician may provide the charging service.

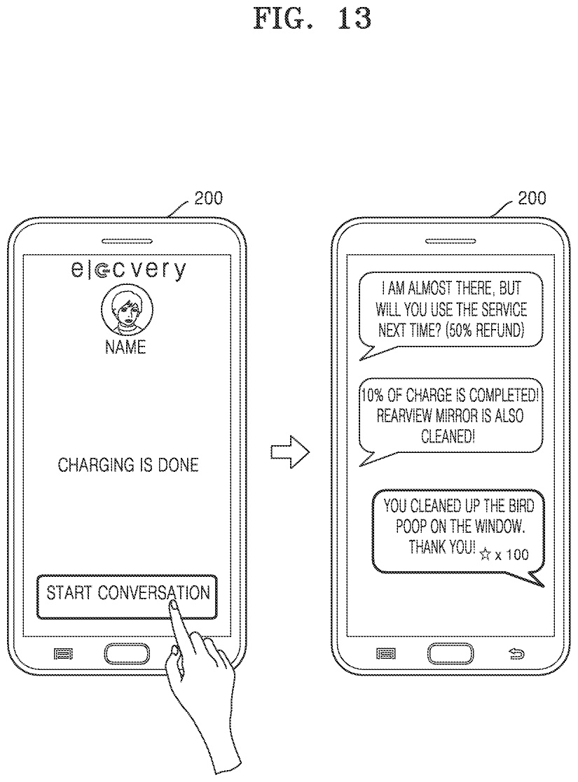

FIG. 13 is a diagram for illustrating a user interface which provides a chatting window for conversations with an charging service technician.

When the providing of the charging service is completed by the charging service technician, a message indicating that charging is completed may be output to the user terminal 200. On the screen of the user terminal 200, a “Start Conversation” button may be also provided to open a conversation space for exchanging conversations with the charging service technician. Through this, the charging service technician may notify the client (user) about problems or additional service matters occurring while providing the charging service. In addition, the client (user) may express gratitude to the charging service technician or provide an item that allows a reward to be sent to the charging service technician through the conversation space. Accordingly, communication between the client (user) and the charging service technician may be facilitated, and the quality of the charging service may be improved.

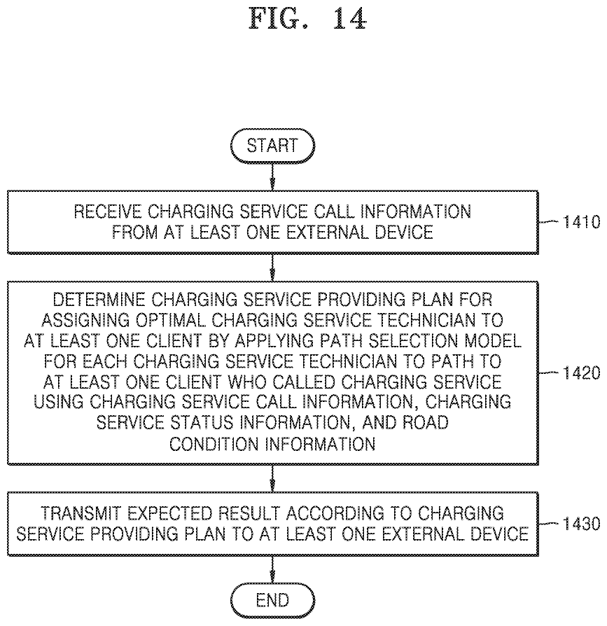

FIG. 14 is a flowchart illustrating a charging service providing method for vehicle charging.

The charging service providing server 300 may perform the charging service providing method for vehicle charging. Terms and contents overlapping with those described above are omitted below.

In the operation of 1410, the charging service providing server 300 may receive charging service call information from at least one external device. The external device may be the vehicle 100 or the user terminal 200. The charging service call information may include vehicle information including charge status information of the vehicle 100, and user selection information such as required charge level, requested charging time, and charging location information.

When the remaining battery level of the vehicle 100 falls below a certain level, the charging service providing server 300 may receive automatic call information based on the charge status information of the vehicle 100 from the external device.

According to an embodiment, in response thereto, the charging service providing server 300 may transmit a charging service providing inquiry to the external device and receive charging service call information from the external device in response to transmitting the charging service providing inquiry. According to an embodiment, when receiving the automatic call information based on the charge status information of the vehicle 100, the charging service providing server 300 may obtain the charging service call information based on information of a user subscribing to the charging service stored in the charging service providing server 300.

In the operation of 1420, the charging service providing server 300 may set one or more paths for each charging service technician to travel to at least one client who called the charging service using the received charging service call information from the at least one external device, charging service status information stored in the charging service providing server 300, and road condition information, may calculate a reward value by applying a path selection model to the one or more paths, the path selection model reflecting the cost of the charging service technician's movement and the gain of providing the charging service, and may determine a charging service providing plan for assigning an optimal charging service technician to the at least one client based on the calculated reward value. The charging service providing server 300 may determine one or more paths along which each charging service technician travels to at least one client, and may calculate a reward value by applying a path selection model to the one or more paths. The charging service providing server 300 may assign the optimal charging service technician to the at least one client based on the calculated reward value.

The path selection model may calculate the reward value by determining the cost of the charging service technician's movement based on the road condition information for each road constituting the path, and determining the gain of charging the charging device at the charging station and the gain of completing the providing of charging service in the process of providing the charging service based on the charging service status information. The cost of the charging service technician's movement may be determined according to detailed road information and traffic information for each road. The gain of completing the providing of charging service may be determined in proportion to the degree to which the requested charging service time by the client overlaps the charging service providing time. The gain of charging the charging device at the charging station may be determined in inverse proportion to the remaining battery level of the charging device.

In the operation of 1430, the charging service providing server 300 may transmit the expected result according to the charging service providing plan to the at least one external device. The charging service providing server 300 may estimate the charging service providing time according to the charging service providing plan, and may transmit the expected result including the estimated charging service providing time to the at least one external device. The charging service providing server 300 may transmit charging service operation information to the charging service technician terminal 400 of the optimal charging service technician corresponding to the charging service providing plan, in response to receiving approval information of the charging service providing plan from the at least one external device.

Each of the above-described embodiments may be provided in the form of a computer program or application stored in a medium to execute certain operations for performing the charging service providing method for vehicle charging in a server. In addition, each of the above-described embodiments may be provided in the form of a computer program or application stored in a medium to execute certain operations for performing a charging service support method for vehicle charging in a terminal device.

In other words, each of the above-described embodiments may be provided in the form of a computer program or application stored in a medium that causes at least one processor of the server to perform certain operations for performing a charging service providing method for vehicle charging. In addition, each of the above-described embodiments may be provided in the form of a computer program or application stored in a medium that causes at least one processor of the terminal device to perform certain operations for performing a charging service support method for vehicle charging.

The above-described embodiments may be implemented in the form of a computer-readable storage medium storing instructions and data executable by a computer or processor. At least one of the instructions and data may be stored in the form of a program code, and when executed by the processor, a certain program module may be generated to perform certain operations. Such a computer-readable storage medium may include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks (SSDs), and any devices capable of storing instructions or software, related data, data files, and data structures, and providing instructions or software, related data, data files, and data structures to a processor or a computer so that the processor or the computer executes the instructions.

Hereinbefore, the embodiments are mainly described. Those skilled in the art to which the disclosed embodiments belong will be able to understand that the disclosed embodiments may be implemented in modified forms within a range not departing from essential characteristics. Therefore, the disclosed embodiments should be considered from an illustrative rather than a limiting point of view. The scope of the disclosure is shown in the claims rather than the description of the above-described embodiments, and all differences within the equivalent scope should be construed as being included in the scope of the disclosure.

1. A charging service providing server for vehicle charging, comprising: a storage;
a communication interface unit;
a memory configured to store instructions; and
a processor configured to, by executing the instructions, receive charging service call information from at least one external device through the communication interface unit, set one or more paths for each charging service technician to travel to at least one client who has called for a charging service, by using the received charging service call information, charging service status information stored in the storage, and road condition information, calculate a reward value by applying a path selection model to the one or more paths, the path selection model reflecting a cost of the charging service technician's movement and a gain of providing the charging service, determine a charging service providing plan for assigning an optimal charging service technician to the at least one client, based on the calculated reward value, and transmit an expected result according to the charging service providing plan to the at least one external device through the communication interface unit.

2. The charging service providing server of claim 1,
wherein the processor is configured to, by executing the instructions,
obtain the charging service call information, based on information of a user subscribing to the charging service stored in the charging service providing server, when receiving automatic call information based on charge status information of a vehicle.

3. The charging service providing server of claim 1,
wherein the path selection model is configured to
calculate a reward value by determining the cost of the charging service technician's movement, based on the road condition information of each road constituting the path, and determining a gain of charging the charging device at a charging station and a gain of completing providing of the charging service in a process of providing the charging service, based on the charging service status information.

4. The charging service providing server of claim 3,
wherein the cost of the charging service technician's movement is determined according to detailed road information and traffic information of the each road,
the gain of completing providing of the charging service is determined in proportion to a degree to which a requested charging service time of the client overlaps with a providing time of the charging service, and
the gain of charging the charging device at the charging station is determined in inverse proportion to a remaining battery level of the charging device.

5. The charging service providing server of claim 1,
wherein the processor is configured to, by executing the instructions,
estimate a charging service providing time according to the charging service providing plan, and transmit the expected result including the estimated charging service providing time to the at least one external device through the communication interface unit.

6. The charging service providing server of claim 1,
wherein the processor is configured to, by executing the instructions,
transmit charging service operation information to a terminal of the optimal charging service technician corresponding to the charging service providing plan through the communication interface unit in response to receiving approval information of the charging service providing plan from the at least one external device.

7. The charging service providing server of claim 1,
wherein the processor is configured to, by executing the instructions,
through the communication interface unit, transmit a charging service providing inquiry to the external device in response to receiving automatic call information based on charge status information of a vehicle from the external device, and receive the charging service call information from the external device in response to the transmitting of the charging service providing inquiry.

8. A charging service providing method for vehicle charging, the method comprising: receiving charging service call information from at least one external device;
setting one or more paths for each charging service technician to travel to at least one client who has called for a charging service, by using the received charging service call information, charging service status information stored in a charging service providing server, and road condition information, calculating a reward value by applying a path selection model to the one or more paths, the path selection model reflecting a cost of the charging service technician's movement and a gain of providing the charging service, and determining a charging service providing plan for assigning an optimal charging service technician to the at least one client, based on the calculated reward value; and
transmitting an expected result according to the charging service providing plan to the at least one external device.

9. The charging service providing method of claim 8,
wherein the receiving of the charging service call information comprises
obtaining the charging service call information, based on information of a user subscribing to a charging service stored in the charging service providing server when receiving automatic call information based on charge status information of a vehicle.

10. The charging service providing method of claim 8,
wherein the path selection model is configured to
calculate a reward value by determining a cost of the charging service technician's movement, based on the road condition information of each road constituting the path, and determining a gain of charging the charging device at a charging station a gain of completing the providing of the charging service in a process of providing the charging service, based on the charging service status information.

11. The charging service providing method of claim 10,
wherein the cost of the charging service technician's movement is determined according to detailed road information and traffic information of the each road,
the gain of completing the providing of the charging service is determined in proportion to a degree to which a requested charging service time of the client overlaps with a providing time of the charging service, and
the gain of charging the charging device at the charging station is determined in inverse proportion to a remaining battery level of the charging device.

12. The charging service providing method of claim 8,
wherein the transmitting of the expected result to the at least one external device comprises:
estimating a charging service providing time according to the charging service providing plan; and
transmitting the expected result including the estimated charging service providing time to the at least one external device.

13. The charging service providing method of claim 8, further comprising
transmitting charging service operation information to a terminal of the optimal charging service technician corresponding to the charging service providing plan in response to receiving approval information of the charging service providing plan from the at least one external device.

14. The charging service providing method of claim 8, further comprising
transmitting a charging service providing inquiry to the external device in response to receiving automatic call information based on charge status information of a vehicle from the external device,
wherein the receiving of the charging service call information comprises
receiving the charging service call information from the external device in response to the transmitting of the charging service providing inquiry.

15. A computer-readable recording medium on which programs to be executed on a computer are recorded, the computer-readable recording medium comprising:
instructions for setting one or more paths for each charging service technician to travel to at least one client who has called for a charging service, by using the received charging service call information, charging service status information stored in a charging service providing server, and road condition information, calculating a reward value by applying a path selection model to the one or more paths, the path selection model reflecting a cost of the charging service technician's movement and a gain of providing the charging service, and determining a charging service providing plan for assigning an optimal charging service technician to the at least one client, based on the calculated reward value; and
instructions for transmitting an expected result according to the charging service providing plan to the at least one external device.
